(19) United States
(12) Patent Application Publication
(10) Pub. No.: US 2024/0347853 A1
(43) Pub. Date: Oct. 17, 2024

(54) BATTERY FIRE PREVENTION SYSTEM, AND METHOD FOR PREVENTING A BATTERY FIRE RESULTING FROM THERMAL RUNAWAY OF A BATTERY CELL

(71) Applicant: AUDI AG, Ingolstadt (DE)

(72) Inventors: Carsten LORENZ, Reichertshofen (DE); Paul SCHNEIDER, Großmehring (DE)

(73) Assignee: AUDI AG, Ingolstadt (DE)

(21) Appl. No.: 18/701,727

(22) PCT Filed: Sep. 30, 2022
(86) PCT No.: PCT/EP2022/077259

§ 371 Date: Apr. 16, 2024

(30) Foreign Application Priority Data
Oct. 25, 2021 (DE) 10 2021 127 623.3

(51) Int. Cl. H01M 50/383; H01M 10/613; H01M 10/625; H01M 10/6568; H01M 10/658; H01M 50/358; H01M 50/392

(52) U.S. Cl. CPC H01M 50/383; H01M 10/613; H01M 10/625; H01M 10/6568; H01M 10/658; H01M 50/358; H01M 50/392; H01M 2200/10; H01M 2220/20

(57) ABSTRACT

A battery fire prevention system for a battery of a motor vehicle including several battery cells for preventing a battery fire resulting from a thermal runaway of a first battery cell of the battery cells of the battery. The battery fire prevention system includes a cell degassing channel connected to the battery cells and into which a gas escaping from a respective battery cell is introduced and discharged to at least one escape opening of the cell degassing channel, a gas flow influencing structure as part of the cell degassing channel, which influences the course of the gas flow flowing through the cell degassing channel, formed by the gas escaping from the first battery cell, and a cooling device for cooling the first battery cell in thermal runaway mode.

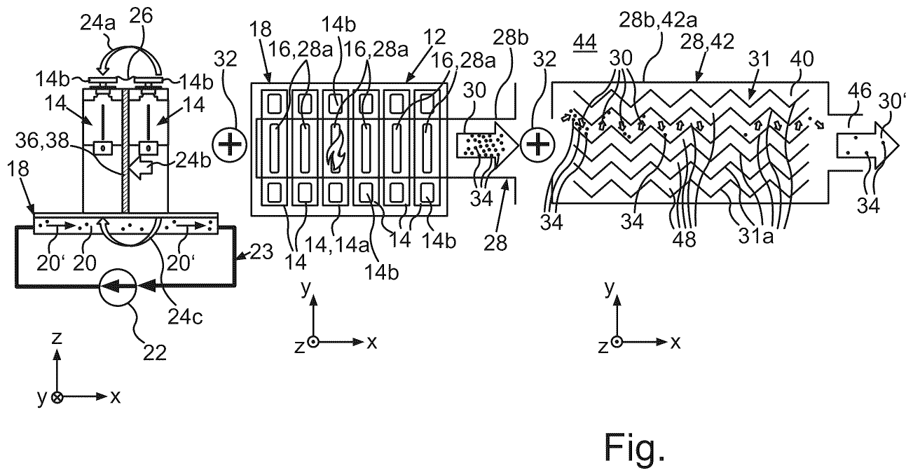

### FIELD

The invention relates to a battery fire prevention system for a battery of a motor vehicle comprising several battery cells for preventing a battery fire resulting from a thermal runaway of one of the battery cells. Furthermore, the invention also relates to a method for preventing a battery fire resulting from a thermal runaway of a battery cell.

### BACKGROUND

Batteries for electric or hybrid vehicles are usually designed as high-voltage batteries and comprise numerous battery cells. Under certain circumstances, for example in the case of an accident or a defect or a short circuit in a battery cell, a thermal runaway of such a battery cell can occur. As a result, this battery cell heats up very strongly and ultimately a gas escape from this battery cell occurs, usually via an exposable gas escape opening provided in the cell. This escaping gas flow also comprises particles, some of which are electrically conductive. Without further countermeasures, these particles can spread throughout the battery housing and lead to a reduction in air and creepage distances, especially in the region of the cell poles and cell connectors, which promotes arc formation, further short circuits and a battery fire. The heating of the cell in runaway mode itself and the hot escaping gas also cause other cells, especially in the immediate environment of the battery cell in runaway mode, to heat up significantly and, as a result, they can also go into thermal runaway mode. Without countermeasures, this will ultimately lead to a thermal propagation across all cells of the battery, ultimately resulting in a high-voltage battery fire.

DE 10 2018 220 992 A1 describes a safety device for an electrochemical energy storage device which has a bursting valve and a cooling device. Hot gases escaping through the bursting valve should therewith be able to be cooled down quickly. For cooling, a cooling plate can be provided, which is also designed as a cooling plate of the battery pack so that the escaping gas can be guided along the underbody of the vehicle or along the cooling plate of the battery pack.

Although a targeted gas removal or cooling can reduce the risk of self-ignition of the escaping gas upon final gas escape from the motor vehicle's escape opening, this does not prevent a thermal runaway of further battery cells starting from the initial battery cell in thermal runaway mode. In the event of a thermal propagation across all cells, so much gas ultimately escapes from the battery that ignition of the gas can no longer be avoided after escaping from a final escape opening. Because especially when numerous battery cells go into thermal runaway mode, the enormous amounts of hot gas resulting therefrom can no longer be cooled efficiently. There is also the risk of the degassing path becoming blocked by the numerous particles that are deposited. In the course of the thermal propagation, the cells inside the battery housing heat up even more, in particular to such an extent that the battery fire in the vehicle can no longer be prevented. Another problem in the event of a thermal runaway is that when such a fault state is detected, the high-voltage on-board electrical system, which is supplied with energy by the battery during normal operation, is deactivated and the battery is immediately decoupled from the rest of the high-voltage on-board electrical system. This means that active cooling, according to which the coolant is actively cooled by a refrigeration circuit, is no longer available for the battery. According to the prior art, attempts are therefore made to prevent a thermal propagation or to extinguish a battery fire using special extinguishing devices.

For example, DE 10 2016 200 368 A1 describes a battery system with a battery module and a coolant circuit system with at least one coolant container and a coolant line which is partially guided through the battery module, wherein the coolant line has an emergency opening in the battery module that is closed by an actuating element which is designed as a pressure-sensitive actuating element which opens at a pressure greater than a threshold value and exposes the emergency opening. Furthermore, the coolant container has a connection for an extinguishing agent hose or an interface for attaching a connection for an extinguishing agent hose. If an extinguishing agent hose is connected to the connection and extinguishing agent is filled in, this leads to increased pressure in the coolant circuit system, which opens the emergency opening in the battery module and allows the coolant to flow into the battery module.

In most cases, suitable extinguishing measures and extinguishing systems can only be used to combat the fire that has already started, as these measures require connecting an extinguishing hose which can only be provided after arrival of the fire brigade.

### SUMMARY

The object of the present invention is therefore to provide a fire prevention system and a method which allow to prevent a fire resulting from a thermal runaway of a battery cell of a battery, in particular inside the battery as well as outside the battery.

A battery fire prevention system according to the invention for a battery of a motor vehicle comprising several battery cells for preventing a battery fire resulting from a thermal runaway of a first battery cell of the battery cells of the battery has a cell degassing channel which can be connected to the battery cells of the battery and into which a gas escaping from a respective one of the battery cells can be introduced and discharged to at least one escape opening of the cell degassing channel, a gas flow influencing structure as part of the cell degassing channel, which is designed to influence the course of the gas flow flowing through the cell degassing channel, which is formed by the gas escaping from the first battery cell, and a cooling device for cooling the first battery cell in thermal runaway mode, wherein the cooling device is configured such that a coolant flows through it, at the latest when the first battery goes into thermal runaway mode.

The invention is based on the knowledge that there are several core elements, in particular three core elements, which only show their effect in combination in order to actually be able to prevent a battery fire, and in particular also a fire outside the battery, and to stop thermal propagation. These core elements comprise a controlled gas guidance which can be achieved by the cell degassing channel which can be connected to the battery cells, a suitable gas treatment during gas discharge, which can be achieved by the gas flow influencing structure, and defined heat conduction paths which prevent the heat from quickly encroaching from battery cell to battery cell, which can be accomplished by the cooling device for cooling at least the cell in thermal runaway mode. Due to the controlled gas discharge, it is possible to prevent the gas, including the electrically conductive particles contained therein, from spreading uncontrollably in the battery housing and triggering further short circuits in the region of the cell connectors and cell poles. The gas flow influencing structure advantageously allows by influencing the course of the gas flow to cool it during the outflow and in particular to filter out particles, as will be explained in more detail later. This allows to prevent spontaneous ignition of the gas flow upon escape from the final escape opening. This in turn affects the likelihood of a fire starting within the battery in two ways. On the one hand, a cooled gas flow no longer transfers as much heat back to the battery cells, and it also prevents heat build-up, which can occur if the gas escaping from the final escape opening catches fire. Such a heat build-up can in turn affect the heat development in the battery system within the motor vehicle, which can therefore advantageously be prevented. These measures are particularly advantageous in combination with the cooling device for cooling the first battery cell in thermal runaway mode, since only in this way, in combination with the described gas discharge, the spread of thermal propagation can be prevented. Because the gas is suitably discharged and the battery cell in thermal runaway mode is also cooled and in particular the heat is transported away from the battery cell in thermal runaway mode and the hot-spot region surrounding it, it is possible to prevent adjacent cells or other cells of the battery from heating up so much that these also go into thermal runaway mode. This in turn affects the efficiency of gas discharge, since in the event that only a single cell goes into thermal runaway mode, only its gas has to be treated suitably, e.g. cooled, filtered and discharged, in order to prevent spontaneous ignition of this gas upon gas escape from the final escape opening. The effects and measures provided for gas treatment by the gas flow influencing structure are therefore all the more efficient if they only act on a small amount of gas. Ultimately, fire formation after gas escape can only be effectively prevented if a cooling device is also provided for cooling of the first battery cell in thermal runaway mode. Conversely, such a cooling device can only work efficiently if, for example, only a few cells, for example only the first battery cell in thermal runaway mode, are to be cooled. Furthermore, a thermal propagation could not be prevented even if the first battery cell in thermal runaway mode is cooled if the gas flow escaping from it is not discharged in a suitable manner. Without suitable gas discharge, further short circuits would occur due to the particles contained in the gas, which would lead to a thermal runaway of further battery cells despite cooling of the battery cell in thermal runaway mode. The cooling effect would then split over several cells and would therefore be significantly more inefficient per cell. Therefore, it is possible to stop a thermal propagation from a cell in thermal runaway mode and to prevent a battery fire in which all battery cells are involved only through the synergistic interaction of the components mentioned.

In the context of the present invention, a system is to be understood in particular as an arrangement or apparatus or device. Since, strictly speaking, several individual devices or components work together for fire prevention, this is referred to here as a system. The battery can preferably be, for example, a high-voltage battery for a motor vehicle, in particular an electric or hybrid vehicle. The battery cells comprised by the battery can optionally be combined into battery modules. Correspondingly, a battery can have several battery modules, each of which comprises several battery cells. The battery can, for example, be provided for arrangement in an underbody region of the motor vehicle, for example approximately in the region between the front and rear axles of the motor vehicle. The battery cells can be formed as lithium-ion cells, for example. The cell degassing channel can generally be defined as a structural spatial boundary of a flow channel. The cell degassing channel can, for example, have a channel wall that separates an interior of the cell degassing channel from an environment. The fact that the cell degassing channel can be connected to the battery cells of the battery should be understood to mean that the cell degassing channel can be arranged on or coupled to the battery cells such that the gas escaping from a respective one of these battery cells can be introduced into the interior of the cell degassing channel. The coupling is here such that preferably the majority of the gas escaping from a respective battery cell can be introduced into the cell degassing channel. Preferably, all or almost all of the gas escaping from of the battery cell is introduced into the interior of the cell degassing channel. The cell poles of the battery cells here are to be attributed to the environment of the cell degassing channel. This can ensure an efficient separation of the outflowing gas from these cell poles. The battery cells can be arranged in a battery housing, for example. The cell degassing channel can partially run within this battery housing and lead out of it, in particular up to a final escape opening from the motor vehicle. This can therefore be provided by the escape opening of the cell degassing channel. Alternatively, another line can be connected to the escape opening of the cell degassing channel up to the final escape opening. The gas flow influencing structure is designed to influence the gas flow in its course. This can comprise a redirection of the gas flow in its flow direction as well as the breakdown of the gas flow into several partial flows. A cooling and filtering effect can be achieved through both redirection and breakdown. Preferably, the gas flow influencing structure is designed to cool the gas flow flowing through the cell degassing channel and/or to filter the gas flow with regard to the particles contained therein.

The cooling device is designed to cool at least the battery cell in thermal runaway mode by a coolant flowing through the cooling device at the latest when the first battery cell is going into thermal runaway mode. The cooling device can not only be associated with the individual, first battery cell, but it can also be a common cooling device for several battery cells. In other words, several battery cells or even all battery cells of the battery can be thermally connected to this cooling device, for example be arranged directly on this cooling device or be mechanically connected to it via a heat-conducting compound or a heat-conducting element. The cooling device comprises cooling channels through which the coolant can flow correspondingly. The cooling device is therefore not only designed as a passive cooling device, but advantageously enables convection of a coolant, which is significantly more efficient in terms of heat removal. In order to cause coolant to flow through the cooling device, a coolant pump can be provided which pumps the coolant through a cooling circuit to which the cooling device is connected or can be connected, for example via a suitable valve device and driving of such a valve device. The coolant itself here does not necessarily have to be cooled. This in turn is based on the knowledge that, although in the event of a cell going into thermal runaway mode active cooling can no longer be provided involving a refrigerant circuit and an electric air conditioning compressor due to the shutdown of the high-voltage system and, as a result, to the shutdown of such an air conditioning compressor or other components, the coolant pump in the cooling circuit, which can be powered by the low-voltage system, can still continue to operate or can be transferred into the active state. The coolant circulated in the cooling circuit to which the cooling device is connected to can then no longer be actively cooled down, but by operating the coolant pump it can be achieved that the heat given off locally to the cooling device by the battery cell in thermal runaway mode can be transported away from this hot-spot region and can be absorbed by other components of the cooling system or the motor vehicle, such as by the coolant itself, and other components coupled to the cooling circuit. As a result, the amount of heat that is transferred from the cell in thermal runaway mode to adjacent cells, in particular via the cooling device, can be significantly reduced. By activating the flow of the coolant by the cooling device, at the latest when the first battery cell goes into thermal runaway mode, the cooling medium, i.e. the coolant, can thus be circulated in order to specifically transport and distribute the heat away from this hot-spot region. Here the thermal capacity of the cooling system as a whole can thus be used to absorb and dissipate the heat and thereby prevent a thermal propagation. The cooling device can therefore thus be operated in an at least semi-active state in which thus the coolant is circulated but the coolant does not necessarily have to be actively cooled. Optionally, however, it is conceivable, for example, to additionally activate a fan, for example a radiator fan, in the region of a heat exchanger in order to thereby achieve a certain cooling effect for cooling the heated coolant. As a coolant, for example, water or a water-glycol mixture are available. But other liquids are also conceivable, as well as, in principle, a gaseous coolant.

In order to activate the cooling device accordingly, at the latest when the first battery cell goes into thermal runaway mode, there are several options available. For example, a detection device can be provided which detects such a thermal runaway mode or an already beginning thermal runaway mode, for example based on a temperature of the battery cell, based on detected electrical variables of the battery cell, such as voltage or current, or also based on a pressure in the battery or the battery module with the first battery cell, a gas composition, or similar. It is particularly advantageous if the cooling device already activates the cooling function, if this is not already active, when the beginning of a thermal runaway mode of the first battery cell is already detected, that is, for example, before this first battery cell outgasses. This can be easily determined, for example, in view of the temperature of the battery cell. Timely activation of the cooling device, or at least a coolant pump, can thus be provided in order to allow the coolant to flow through the cooling device.

In a further advantageous configuration of the invention, the gas flow influencing structure is designed to filter particles carried in the gas flow and/or to prevent them from reaching the escape opening. Such a filtering effect can be achieved in a variety of ways. Filtering such particles has the great advantage that the probability of the gas spontaneously igniting upon escape from the final escape opening can be significantly reduced. These particles represent ignition sources so they should be prevented from escaping from the final escape opening, if possible. For particle filtering, appropriate filters can be integrated, for example, into the gas discharge path which is provided by the cell degassing channel. For example, it is also conceivable to achieve such particle separation and filtering by redirecting the gas discharge path, in particular redirecting it several times, for example zigzag-shaped or snake-shaped. This can be achieved, for example, by having the gas discharge path itself designed to be correspondingly winding or curved in its extension direction. However, it is preferred if corresponding redirection structures are integrated inside the gas discharge channel. For example, baffle sheets can be integrated into these, which effect such gas flow guidance. For this purpose, for example, a plurality of sheets arranged parallel to one another and running in a zigzag or wave-shaped manner can be provided in a chamber of the gas discharge channel, which separate the gas discharge path into a plurality of, in particular numerous, partial paths running parallel to one another, which vary alternately, in particular in the main running direction, with respect to at least one direction perpendicular to the main running direction, for example periodically or wave-shaped or zigzag-shaped, respectively. It is also conceivable to arrange several perforated sheets one behind the other in the main running direction, with each perforated sheet having numerous small holes. The diameter of the holes can be reduced in the main running direction from perforated sheet to perforated sheet. This results in a gradual particle separation. At the same time, these measures not only lead to particle separation, but also to the gas flow being slowed down and thereby also cooling down and, for example, also releasing energy to the structures described.

Accordingly, it represents a further very advantageous configuration of the invention if the gas flow influencing structure is designed to reduce a flow velocity of the gas flow, in particular by redirecting a flow direction of the gas flow flowing in the cell degassing channel. This can also be implemented, for example, by the particle filtering measures already described above. For example, the sheets arranged parallel to each other, running in a snake-shaped or wavy manner, are also suitable for achieving such a redirection of the flow direction, in several sequences, whereby not only a particle separation but also a corresponding cooling of the gas flow can be achieved. Likewise, such a redirection of the flow direction can be achieved by the perforated sheets described, in particular if the perforated sheets are aligned with each other such that the holes, viewed in the main flow direction, are not aligned with each other, but are at least slightly or completely offset from each other. A redirection of the gas flow can also be implemented by forming labyrinth-like structures within the cell degassing channel. The variants described can also be combined with one another, for example by forming further sub-channels within the cell degassing channel, which, for example, have channel walls that are gas-permeable in some regions or parts. These then fulfill a similar effect as the perforated sheets and, for example, enable a gas flowing into a chamber to be distributed as homogeneously as possible to a maximum volume provided by the chamber of the cell degassing channel, as will be explained in more detail later.

In a further advantageous configuration of the invention, the cell degassing channel has a wall that separates an interior of the cell degassing channel from an environment, wherein the gas flow influencing structure is arranged in the interior of the cell degassing channel. By a gas flow influencing structure arranged inside the cell degassing channel, significantly more efficient particle separation and gas flow cooling can be achieved than, for example, if gas redirection is to be achieved through the geometric design and guidance of the cell degassing channel itself. By such gas flow influencing structures integrated into the interior of the cell degassing channel, the collision surface with which the gas collides as it flows through the cell degassing channel can be increased, which allows more efficient cooling and particle separation.

It is also very advantageous if the cell degassing channel comprises, for example, a gas discharge chamber, which can also simply be referred to as a chamber and in which a gas distribution structure is arranged as a gas flow influencing structure, which distributes the gas entering the chamber through at least one inlet opening thereof in the interior of the chamber before it leaves the chamber again through at least one escape opening thereof. Such a chamber can, for example, be provided as a space directly below and/or above the battery, for example between a battery base and an underride guard of the motor vehicle. This chamber thus extends, for example, in length and width over a majority of the battery, in particular also over the entire battery. This means that very large dimensions of such a chamber can be provided, at least in two dimensions. The gas escaping from a cell can, for example, be introduced directly upwards or downwards into this chamber. A respective inlet opening can be provided in the chamber for each battery cell or battery module of the battery. In other words, the chamber can also comprise several inlet openings and not just a single one.

The gas discharge chamber is designed, for example, such that a gas escaping from the at least one first battery cell, which is introduced into the gas discharge chamber through the at least one inlet opening, can be passed through the gas discharge chamber to the at least one escape opening and can be discharged from the at least one escape opening. The gas discharge chamber has the gas distribution structure arranged in the interior of the gas discharge chamber, which is designed to distribute a gas introduced into the gas discharge chamber via the at least one first inlet opening before escaping from the at least one escape opening in the interior of the gas discharge chamber.

According to a further advantageous configuration of the invention, the gas distribution structure has at least one gas discharge channel arranged in a first region of the interior, which has at least one partially gas-permeable channel wall, which at least partially separates the first region from the second region of the interior, wherein the at least one first inlet opening opens into the second region of the interior and wherein the at least one escape opening opens into an interior of the gas discharge chamber in the first region, wherein the at least one channel wall is designed such that a gas permeability of the channel wall varies depending on a distance from the at least one escape opening of the chamber, for example, increases with increasing distance.

In a further advantageous configuration of the invention, the gas distribution structure has several gas discharge channels comprising the at least one gas discharge channel, wherein the gas discharge channels are arranged at a distance from one another, wherein an escape opening of several escape openings of the gas discharge chamber opens into each gas discharge channel, and wherein a respective gas discharge channel has two opposing gas-permeable channel walls.

It is also conceivable that the gas flow influencing structures described are also designed so that a coolant can flow through them and such a coolant flows through them, at least at the latest when gas escapes from the first battery cell. This allows additional gas cooling to be provided.

Furthermore, the invention also relates to a battery arrangement having a battery fire prevention system according to the invention or one of its configurations.

Here it is preferred that the battery arrangement comprises the battery with the several battery cells. A respective one of the battery cells can also have an exposable degassing opening which is coupled to the cell degassing channel.

According to an advantageous configuration of the invention, the battery arrangement therefore comprises the battery with the several battery cells, wherein a respective one of the battery cells has an exposable degassing opening which is connected to an associated, at least exposable inlet opening of the cell degassing channel in a sealed manner by means of a seal which is designed to at least partially prevent a gas escaping from the degassing opening from emerging into an environment of the cell degassing channel. By such a sealed coupling between the battery cell and the cell degassing channel, the risk that gas can emerge into the environment through the space between the battery cell and the cell degassing channel can advantageously be minimized. The cell poles of the battery cells are located in the environment here. This allows the gas to be kept away from these cell poles and the cell connectors connected to them in a particularly efficient manner. The cell degassing channel can, for example, have as part of its channel wall a channel wall facing the battery cell arrangement, in which exposable channel openings are provided which are coupled to the associated degassing openings of the battery cells or are connected to them via the seal. These at least exposable openings in the channel wall can be provided as permanent openings or as openings that are only exposed in the event of degassing and which can also be designed as bursting membranes, for example. The seals can be designed here, for example, as high-temperature seals. The sealing connection can however also be designed as a metallic collar or ring or similar.

In a further very advantageous configuration of the invention, the cooling device is connected to at least one side of a respective one of the battery cells and/or arranged, via an electrical insulation, on cell connectors by means of which the battery cells are electrically connected. The battery cells can be arranged in a specific arrangement relative to one another. If the battery cells are provided, for example, in the form of prismatic battery cells, they can be arranged, for example, in the form of a cell stack with several battery cells arranged next to one another in a stacking direction. If the cells are designed as round cells, for example, they can be arranged on a carrier which is simultaneously designed as the cooling device, in particular with one of their end sides facing the carrier, wherein the battery cells can also be arranged in a matrix-like arrangement on the carrier, or also with rows offset from one another, so that each round cell is surrounded by six further round cells as its nearest neighbors, unless it is a fringe cell. The cells may, for example, have a first side, which in the case of round cells, for example, may represent an end side on which the cell poles or at least one of the cell poles is arranged. The first side of the battery cell therefore refers to a side on which at least one cell pole of the battery cell is arranged. The cooling device is thus preferably connected to a side of the battery cell that is different from the first side. Additionally or alternatively, the cooling device can also be connected via an electrical insulation to the cell poles themselves or to the cell connectors that electrically contact the cell poles among each other. The cooling device can therefore also have several cooling units, for example one that is connected to a side of the battery cells that is different from the first and one that cools the cell connectors or cell poles. The cells can also be designed as pouch cells and the cooling can be connected to a suitable side of these pouch cells. Thereby, there are numerous different configurations that can be employed for cooling the battery cells.

It is also particularly advantageous if a thermal insulation element is arranged between two adjacent battery cells of the several battery cells each. Such a thermal insulation element can be provided, for example, by a ceramic plate or mica plate, an insulating casting compound or the like. The thermal insulation element is preferably also designed to be electrically insulating. Thereby, the spread of heat from the affected first cell in thermal runaway mode to other adjacent cells can be slowed down. By the additional cooling and the gas discharge described it can simultaneously be achieved that so little heat is transferred to adjacent cells that thermal runaway of these adjacent cells can be prevented.

Furthermore, the invention also relates to a motor vehicle with a battery arrangement according to the invention or one of its configurations.

The motor vehicle according to the invention is preferably designed as an automobile, in particular as a passenger car or truck, or as a passenger bus or motorcycle.

Furthermore, the invention also relates to a method for preventing a battery fire resulting from a thermal runaway of a first battery cell of several battery cells of a battery, wherein a gas escaping from the first battery cell is introduced into a cell degassing channel connected to the battery cells of the battery and is discharged to at least one escape opening of the cell degassing channel, the gas flow which is formed by the gas escaping from the first battery cell is influenced in its course by a gas flow influencing structure as part of the cell degassing channel, and the first battery cell in thermal runaway mode is cooled by a cooling device through which a coolant flows.

The advantages mentioned for the battery fire prevention system according to the invention and its configurations as well as the battery arrangement according to the invention and its configurations thus apply similarly to the method according to the invention.

The invention also includes refinements of the method according to the invention, which have features as already described in the context of the refinements of the fire prevention system according to the invention and the battery arrangement according to the invention. For this reason, the corresponding refinements of the method according to the invention are not described again here.

The invention also comprises the combinations of the features of the described embodiments. The invention therefore also comprises implementations that respectively have a combination of the features of several of the described embodiments, provided that the embodiments have not been described as mutually exclusive.

Exemplary embodiments of the invention are described hereinafter. The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

### BRIEF DESCRIPTION OF THE FIGURE

The single FIGURE shows a schematic representation of the main components of a fire prevention system 10 according to an exemplary embodiment of the invention.

### DETAILED DESCRIPTION

The fire prevention system 10 serves for a fire prevention of a battery fire in a battery 12 which comprises several battery cells 14, which results from the thermal runaway of a first battery cell 14a of the several battery cells 14. Such a battery 12 is illustrated, for example, in the middle representation in the FIGURE. A respective battery cell 14 can also have an exposable cell degassing opening 16 which opens upon excess pressure within the battery cell 14 concerned in order to enable controlled outgassing of the battery cell 14 concerned, such as the battery cell 14a in thermal runaway mode in this example. The battery 12 can be designed, for example, as a high-voltage battery for a motor vehicle, in particular an electric or hybrid vehicle. In the left illustration in the FIGURE, two such battery cells 14 are shown again as examples. These are arranged on a carrier 18 which is also designed as a cooling base and can accordingly be flowed through by a coolant 20. In order to allow the coolant 20 to flow through this carrier 18 which simultaneously represents a cooling device 18, a coolant pump 22 is used, for example. The cooling circuit is designated 23 here. Through this, the coolant 20 is circulated by pumping and the cooling device 18 is connected to this cooling circuit 23. All battery cells 14 can be arranged on a common carrier 18 designed as a cooling device 18, or separate such cooling devices 18 can be provided for certain cell groups with several battery cells 14 each.

Basically, there are several thermal coupling paths 24a, 24b, 24c between two battery cells 14 arranged adjacent to each other, as shown on the left in the FIGURE. On the one hand, the cell poles 14b of a respective battery cell 14 are coupled or electrically conductively connected to those of an adjacent battery cell 14 via electrically conductive cell connectors 26. A first heat transfer path 24a is provided via this cell connector 26. If, in the event of a thermal event in a battery cell 14, a lot of heat is generated in such a battery cell 14, this is transferred very quickly to the adjacent battery cell 14 via such a cell connector 26 without any further countermeasures. The cooling device 18, which for example can be provided in the form of a metallic plate provided with flow channels, thermally couples adjacent cells 14 very well when the coolant 20 is not flowing through this plate 18. This also provides a very good thermally conductive heat transfer path 24c, at least in the inactive state of the cooling device 18. Another heat transfer path 24b is provided between the cell surfaces facing each other between the battery cells 14.

If a thermal event occurs in a battery cell in a conventional battery without countermeasures, this battery cell heats up very strongly in the course of its thermal runaway and gas ultimately escapes from this battery cell. If the electrically conductive particles contained in this gas flow in particular get into the region of the poles of the battery cells, they can lead to additional short circuits which in turn can trigger the thermal runaway of further battery cells. Heat can also be transferred to other cells via the described thermal paths between the cells. If they also heat up very strongly, they will also go into thermal runaway mode.

By the invention and its embodiments, it is now advantageously possible to prevent an overall battery fire resulting from a thermal runaway of a battery cell 14a by the battery fire prevention system 10. As already mentioned, this comprises several main components. These are, on the one hand, the already mentioned cooling device 18, a cell degassing channel 28 that can be connected to the battery cells 14 for the targeted gas removal of the gas flow 30 escaping from the cell 14a in thermal runaway mode, and a gas flow influencing structure 32 as part of the cell degassing channel 28. The fire-preventing effect of the fire prevention system 10 itself can be achieved here solely through the combination of these main components. The combination is illustrated in the FIGURE by the addition symbols 32. This is based on the knowledge that efficient gas discharge is only possible if not all battery cells 14 of battery 12 go into thermal runaway mode. The targeted gas discharge is in turn necessary to prevent further short circuits of other still intact cells 14 in order to avoid a thermal propagation. It must also be possible to provide the best possible thermal decoupling between the cells 14, which is enabled by the cooling device 18. This is also only possible if not too many battery cells 14 go into thermal runaway mode as otherwise an efficient cooling can no longer be provided. Accordingly, a suitable gas discharge must be ensured, since otherwise the particles 34 contained in the gas flow 30 can cause short circuits and arcs within the battery 12, which promote a thermal propagation despite cooling. The gas flow influencing structure 31 also ensures sufficient particle separation and gas cooling of the gas flow 30 so that the ultimately escaping gas flow 30′ comprises significantly fewer particles 34 or no particles 34 at all and is significantly cooler than the gas flow 30 escaping from the cell 14a concerned. A fire starting outside the battery 12, in particular upon escape from a final escape opening, can thereby also be overcome. The functionality of these explained main components will now be described in more detail below.

The cooling device 18, as shown on the left in the FIGURE, is flowed through by a coolant 20, at the latest when a battery cell 14a goes into thermal runaway mode. The through-flow is achieved by means the pump 22 as described. Furthermore, this through-flow of the cooling device 18 is illustrated by the arrows 20′. This does not necessarily have to be accompanied by active cooling of the coolant 20. The cooling device 18 can thus function as inactive cooling. This is in turn based on the knowledge that in the event of a detected defect in the battery 12, such as the thermal runaway of a battery cell 14a, the battery 12 is separated from the rest of the high-voltage on-board electrical system, which means that the high-voltage on-board electrical system is switched off. This means that various components that are usually used to cool the coolant 20, such as the operation of an electric air conditioning compressor in a refrigerant circuit, can no longer be used. By the pump 22, which can be supplied by a low-voltage electrical on-board network of the motor vehicle, the coolant 20 can still be circulated within the cooling circuit 23 and thus efficiently transport away the heat generated in the affected cell 14a. The extent of heat transfer via the thermal path designated 24c can thus be enormously reduced. Although not shown here, such a cooling device 18 can alternatively or additionally also be connected to the cell poles 14b or the cell connectors 26, for example via an electrical insulation. In this way, heat transfer via the thermal path designated 24a can also be reduced in the same way. In principle, however, cooling on one of the sides of the cells 14 is also sufficient since, for example, sufficient heat can be removed by the underside cooling 18 shown here, so that ultimately hardly any heat can be transferred via the upper thermal path 24a. The same also applies to the path 24b between the cells 14. In order to additionally reduce the heat transfer via this middle thermal path 24b, it is also preferred that a thermal insulation element 38 is arranged in the interspace 36 between the cells. Thereby the heat transfer between the cells 14 can be additionally reduced in this region. This makes it possible to create defined heat conduction paths, namely in the direction of the cooling structure 18, while at the same time the paths between the cells 14 are eliminated or reduced.

Furthermore, the gas 30 escaping from the affected cell 14a can be introduced into a cell degassing channel 28, as already mentioned, as illustrated in the middle representation in the FIGURE. Thereby a controlled gas guidance can be achieved and the escaping gas 30 can be kept separated from the cell poles 14b. Thereby arc forming and further short circuits can be overcome. For this purpose, the cell degassing channel 28 can be attached to or connected to the respective degassing openings 16 of the cells 14, which are designed, for example, as bursting membrane openings, with a seal. For this purpose, the cell degassing channel 28 can, for example, have inlet openings 28a corresponding to the respective degassing openings 16 of the cells 14. In the FIGURE, the middle illustration shows the battery 12 in a plan view of the degassing openings 16 and the inlet openings 28a located above them in the z-direction. These inlet openings 28a can also be designed, for example, as permanent openings or as bursting membranes.

But without countermeasures, the temperature of this outflowing hot gas 30 can also have a retroactive effect on the temperature of the battery cells 14. It is therefore advantageous that the gas flow influencing structure 31 is additionally provided as part of the cell degassing channel 28. This allows additional facilitation for gas cooling and particle separation. Such a gas flow influencing structure 31 can take on various forms. In principle, it is preferred that this is integrated into an interior 40 of the cell degassing channel 28. The cell degassing channel 28 can, for example, also comprise a chamber 42 as a portion, in the interior 40 of which this gas flow influencing structure 31 is integrated. In order to separate this interior 40 from an environment 44, the cell degassing channel 28 or the chamber 42 has a corresponding wall 28b, 42a. The wall 42a of the chamber 42 is part of the wall 28b of the entire cell degassing channel 28. The gas 30 can be conducted through this chamber 42 to an escape opening 46 of the chamber 42 or the cell degassing channel 28. This can correspond to a final escape opening from the motor vehicle in which the battery fire prevention system is applied, or a further line for gas removal can be connected to this escape opening 46 up to a final escape opening. Such a chamber 42 can in principle also be arranged directly above or below the battery 12, so that, for example, the inlet openings 28 described open directly into this chamber 42. The gas flow influencing structure 31 now advantageously enables gas cooling of the gas flow 30 and particle separation of the particles 34. In this example, the structure 31 comprises numerous structural elements 31a which can be designed, for example, as zigzag-shaped or wave-shaped running sheets which thus provide numerous partial paths 48 which also run wave-like or zigzag-shaped in the x-direction in their interspaces. Due to this zigzag-shaped or wave-shaped structure, the gas flow 30 is redirected several times in and against the y-direction in a respective partial path 48. This causes particles 34 to be separated and the gas flow slows down. In addition, thermal energy is released to the structural elements 31a. These can also, for example, be designed so that a coolant can flow through them and flows through them during gas removal in order to provide additional gas cooling.

The gas flow influencing structure 31 can also take on numerous other forms not shown here. For example, this can be provided as one or more perforated sheets arranged one behind the other in the x-direction. The perforated sheets are preferably aligned in the x-direction, which corresponds to a main flow direction or at least local main flow direction, and each have several holes. These can have diameters in the range between one millimeter and ten millimeters. This can provide a filtering effect for filtering and separating the particles 34. By an offset arrangement of the holes with regard to each other in the respective perforated plates, multiple redirection and division of the gas flow 30 can also be achieved, which results in promoted particle separation and braking of the gas flow.

Overall, the examples show how a safety concept of an NTP (No Thermal Propagation) high-voltage battery system can be provided, by means of which a high-voltage battery fire can be prevented in the event of a thermal runaway. In particular, a safety concept can be provided which, when integrated into a high-voltage battery system, can lead to NTP behavior. In other words, this safety concept can stop a thermal propagation and prevent an overall battery fire in the battery as well as outside the battery. The security concept preferably contains three main components which have an effect in combination. These comprise defined heat conduction paths as the first component, in particular by employing the heat capacity of the cooling system, by thermally connecting the electrical cell connections and cells to cooling media, and by thermal insulation between the cells, and as the second component a controlled gas flow, in particular through an independent gas channel, which preferably is connected to the bursting membrane openings of the cells with a seal, and as a third component, particle filtering and gas cooling, in particular through a special filter system with a sufficiently large cooling capacity. Therefore, if a cell goes into thermal runaway mode, there will be no propagation in the high-voltage battery system and no fire will result inside or outside the high-voltage battery system.

1-10. (canceled)

11. A battery fire prevention system for a battery of a motor vehicle comprising several battery cells for preventing a battery fire resulting from a thermal runaway of a first battery cell of the battery cells of the battery,
wherein the battery fire prevention system has:
a cell degassing channel which can be connected to the battery cells of the battery and into which a gas escaping from a respective one of the battery cells can be introduced and discharged to at least one escape opening of the cell degassing channel; and
a gas flow influencing structure as part of the cell degassing channel, which is designed to influence the course of the gas flow flowing through the cell degassing channel, which is formed by the gas escaping from the first battery cell;
wherein the battery fire prevention system has a coolant pump for circulating a coolant within a cooling circuit, a cooling device for cooling the first battery cell in thermal runaway mode, and the cooling circuit to which the cooling device is connected to or can be connected to and through which the coolant can be circulated by pumping by the coolant pump for cooling the first battery cell in thermal runaway mode,
wherein the cooling device is configured such that the coolant flows through it, at the latest when the first battery cell goes into thermal runaway mode.

12. The battery fire prevention system according to claim 11, wherein the gas flow influencing structure is designed to filter particles carried in the gas flow and/or to prevent them from reaching the escape opening.

13. The battery fire prevention system according to claim 11, wherein the gas flow influencing structure is designed to reduce a flow velocity of the gas flow, in particular by redirecting a flow direction of the gas flow flowing in the cell degassing channel.

14. The battery fire prevention system according to claim 11, wherein the cell degassing channel has a wall which separates an interior of the cell degassing channel from an environment, wherein the gas flow influencing structure is arranged in the interior of the cell degassing channel.

15. A battery arrangement with a battery fire prevention system according to claim 11.

16. The battery arrangement according to claim 15, wherein the battery arrangement comprises the battery with the several battery cells, wherein a respective one of the battery cells has an exposable degassing opening which is connected to an associated, at least exposable inlet opening of the cell degassing channel in a sealed manner by a seal which is designed to at least partially prevent a gas escaping from the degassing opening from emerging into an environment of the cell degassing channel.

17. The battery arrangement according to claim 15, wherein the cooling device is connected to at least one side of a respective one of the battery cells and/or is arranged, via an electrical insulation, on cell connectors by means of which the battery cells are electrically connected.

18. The battery arrangement according to claim 15, wherein a thermal insulation element is arranged between two adjacent battery cells of the several battery cells each.

19. A motor vehicle with a battery arrangement according to claim 15.

20. A method for preventing a battery fire resulting from a thermal runaway of a first battery cell of several battery cells of a battery,
wherein a gas escaping from the first battery cell is introduced into a cell degassing channel connected to the battery cells of the battery and is discharged to at least one escape opening of the cell degassing channel; and
the gas flow which is formed by the gas escaping from the first battery cell is influenced in its course by a gas flow influencing structure as part of the cell degassing channel;
wherein a coolant pump circulates coolant within a cooling circuit to which a cooling device for cooling the first battery cell in thermal runaway mode is connected to and through which the coolant is circulated by pumping by the coolant pump for cooling the first battery cell in thermal runaway mode,
wherein at least the first battery cell in thermal runaway mode is cooled by the cooling device through which the coolant flows.

21. The battery fire prevention system according to claim 12, wherein the gas flow influencing structure is designed to reduce a flow velocity of the gas flow, in particular by redirecting a flow direction of the gas flow flowing in the cell degassing channel.

22. The battery fire prevention system according to claim 12, wherein the cell degassing channel has a wall which separates an interior of the cell degassing channel from an environment, wherein the gas flow influencing structure is arranged in the interior of the cell degassing channel.

23. The battery fire prevention system according to claim 13, wherein the cell degassing channel has a wall which separates an interior of the cell degassing channel from an environment, wherein the gas flow influencing structure is arranged in the interior of the cell degassing channel.

24. The battery arrangement according to claim 16, wherein the cooling device is connected to at least one side of a respective one of the battery cells and/or is arranged, via an electrical insulation, on cell connectors by means of which the battery cells are electrically connected.

25. The battery arrangement according to claim 16, wherein a thermal insulation element is arranged between two adjacent battery cells of the several battery cells each.

26. The battery arrangement according to claim 17, wherein a thermal insulation element is arranged between two adjacent battery cells of the several battery cells each.
